(19) United States
(12) Patent Application Publication
(10) Pub. No.: US 2011/0271084 A1
(43) Pub. Date: Nov. 3, 2011

(54) Information processing system and information processing method

(75) Inventors: Hiroki Moue, Kawasaki (JP); Nobutaka Imamura, Kawasaki (JP); Hiromichi Kobashi, Kawasaki (JP); Yuichi Tsuchimoto, Kawasaki (JP); Miho Murata, Kawasaki (JP); Toshiaki Saeki, Kawasaki (JP); Yasuo Yamane, Kawasaki (JP)

(73) Assignee: FUJITSU LIMITED, Kawasaki (JP)

(21) Appl. No.: 13/064,459

(22) Filed: Mar. 25, 2011

(30) Foreign Application Priority Data
Apr. 28, 2010 (JP) 2010-104293

(51) Int. Cl. G06F 9/30

(52) U.S. Cl. 712/220; 712/E09.016

(57) ABSTRACT

A disclosed information processing system includes a receiving node and a storing node, the receiving node includes an order information adding unit that adds first order information to operation instructions included in an operation instruction sequence, the first order information indicating an order among the operation instruction sequences and an operation instruction transmission unit that transmits the one or more operation instructions to the storing node, the storing node includes an operation instruction execution unit that executes the operation instructions. Further, upon a receipt of a second operation instruction having the first order information indicating that the second operation instruction is earlier than the one or more first operation instructions, which was already executed, in the first order relationship, the storing node re-executes the first operation instruction after the second operation instruction is executed.

### CROSS-REFERENCE TO RELATED APPLICATIONS

This application is based upon and claims the benefit of priority of Japanese Patent Application No. 2010-104293, filed Apr. 28, 2010. The entire contents of which are incorporated herein by reference.

### FIELD

The embodiment discussed herein is related to an information processing system and an information processing method.

### BACKGROUND

Japanese Laid-Open Patent Application No. 10-116215 discloses a time stamp scheduling method to improve the concurrency of moving transactions and the performance of the moving data processing system by checking the time stamp by transaction scheduler at the ending stage of a transaction.

Japanese Laid-Open Patent Application No. 10-69418 discloses a hierarchized transaction processing method to assure the total atomicity of many transactions which are latently scattered and also optimize the traffic preferably for cooperation of those transactions and the total parallel behavior and throughput of the transactions.

Japanese Laid-Open Patent Application No. 2008-525923 discloses transaction-based shared data operations in a multiprocessor environment for handling shared memory accesses between multiprocessors utilizing lock-free synchronization through transactional execution.

### SUMMARY

According to an aspect of the present invention, an information processing system includes one or more receiving nodes, each receiving an execution request for executing an operation instruction sequence including one or more operation instructions to be sequentially executed, the one or more operation instructions being related to one or more data and one or more storing nodes, each storing data to be operated based on the one or more operation instructions. Further, in the receiving node includes an order information adding unit that adds first order information to the one or more operation instructions included in each of the operation instruction sequences, the first order information indicating a first order relationship among the operation instruction sequences, and an operation instruction transmission unit that transmits the one or more operation instructions to the one or more storing nodes. Further, the storing node includes an operation instruction execution unit that executes the one or more operation instructions related to the data stored in the storing node in response to the receipt of the one or more operation instructions. Further, upon a receipt of a second operation instruction having the first order information indicating that the second operation instruction is earlier than the one or more first operation instructions, which was already executed, in the first order relationship, the storing node re-executes the first operation instruction after the second operation instruction is executed.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example drawing illustrating an exemplary configuration of an information processing system according to an embodiment of the present invention;

FIG. 2 is an example drawing illustrating an exemplary hardware configuration of the information processing system according to an embodiment of the present invention;

FIG. 3 is an example drawing illustrating exemplary functional configurations of a receptor and a container;

FIG. 4 is an example flowchart illustrating a processing procedure performed by the receptor upon reception of operation instruction sequence;

FIG. 5 is an example drawing illustrating an example of transitions of the operation instruction sequences in a processing procedure;

FIG. 6 is an example flowchart illustrating a processing procedure performed by the container upon receipt of the operation instruction sequence;

FIG. 7 is an example drawing illustrating an exemplary configuration of an operation instruction execution history storage section in FIG. 3;

FIG. 8 is an example drawing illustrating an exemplary configuration of a confirmation state storage section in FIG. 3;

FIG. 9 is an example flowchart illustrating a processing procedure performed by the container of a dependence destination in a callback process;

FIG. 10 is an example flowchart illustrating a processing procedure performed by the container of a dependence source in the callback process;

FIG. 11 is an example flowchart illustrating a processing procedure performed by the receptor in response to an execution report;

FIG. 12 is an example of a sequence diagram of a confirmation protocol;

FIG. 13 illustrates an example in which an operation instruction sequence interrupts another operation instruction sequence;

FIG. 14 illustrates an example in which an execution order of operation instructions in one operation instruction sequence is inverted; and

FIG. 15 illustrates an example in which an execution result goes wrong due to a speculative execution of an operation instruction performed by a node serving as the dependent destination.

### DESCRIPTION OF EMBODIMENT

The term “distributed transaction” refers to a processing mode in which processes belonging to one transaction are distributed to and executed by plural nodes (computers). Further, the term “transaction” refers to a unit of information processing in which plural processes relevant to each other are executed as a unit of processing.

Like a transaction monitor, there is an example technique in which the processes being distributed to be executed are gathered into one and then serialized. Further, there is another technique in which, in the distributed transaction, data to be processed are locked so that the processes to be distributively executed are logically serialized.

However, in this technique as serializing the processes to be distributively executed, parallelism of the processes may be lost. Further, due to the communication load necessitated by the serialization or the synchronization of the processes, it may be difficult to improve the processing performance. The larger the number of the nodes used in the distributed transaction is increased, the larger the communication load is likely to become. In other words, the larger the scale of the system processing the distributed transaction becomes, the further the processing performance degrades.

An embodiment is made in light of the above circumstances and may provide an information processing system and an information processing method improving the parallelism of an operation instruction sequence performed on data distributively managed.

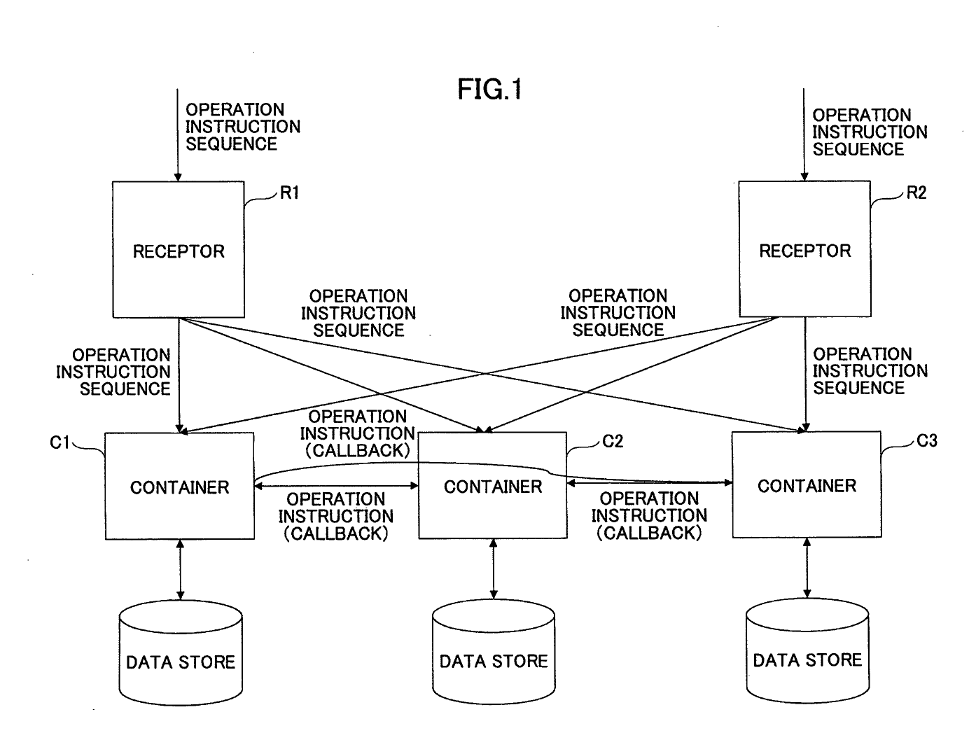

In the following, embodiments of the present invention are described with reference to the accompanying drawings. FIG. 1 illustrates an exemplary configuration of an information processing system according to an embodiment of the present invention. As illustrated in FIG. 1, an information processing system 1 includes one or more receptors R such as receptors R1 and R2 and one or more containers C such as containers C1, C2, and C3.

Herein, the receptor R refers to a node that receives a request for executing an operation instruction sequence. The operation instruction sequence refers to an array having one or more operations instructions as a unit of processing to be sequentially executed (sequential execution). The operation instruction sequence may be similar to the concept generally called transaction. However, it may be noted that the operation instruction sequence in this embodiment of the present invention includes not only a consistent operation instruction sequence but also an eventual operation instruction sequence. In the “consistent” operation instruction sequence, it may be required to maintain a sequential relationship in the operation instruction sequence. On the other hand, in the “eventual” operation instruction sequence, it may not be required to maintain the sequential order in the operation instruction sequence. Herein, the term “operation instruction sequence” is simply used when it is not necessary to distinguish between the “consistent” operation instruction sequence and the “eventual” operation instruction sequence.

Further, the term “operation instruction” refers to an execution instruction (execution command) to perform an operation on data to be managed in the information processing system 1. For example, the operation includes various processes changing the status of data, obtaining data, deleting data and the like. The receptor R transmits the received operation instruction sequence to the container C corresponding to (storing) the data to be operated on in the operation instruction sequence.

On the other hand, the container C is a node that retains or stores the data to be managed in the information processing system 1 in a key-value store format using data store. The term “key” refers to a data name, and the term “value” refers to an entity (instance) of the data (hereinafter simplified as “data”). Therefore, a distributed key-value store is achieved using plural containers C. In the distributed key-value store, the nodes (i.e., containers C in this embodiment) having the respective data are uniquely determined based on the corresponding keys (i.e., data names). In this embodiment, for convenience, it is assumed that each container C has one data. However, this assumption does not mean that the present invention excludes a configuration where one container C has two or more data. The container C executes the operation instruction on the data stored in the container C, the operation instruction having been received from the receptor R. Therefore, the operation instruction may refer to an instruction of the operation to be executed using the data as a unit that can be accepted by the container C. Further, among the containers C, the operation instruction is called based on a system called callback. The term “callback” refers to a system to realize the execution of the operation instruction sequence under the condition that a dependency relationship between the operation instructions is maintained. Herein, the term “dependency relationship between the operation instructions” refers to a relationship in which the execution result of one operation instruction influences the other operation instruction between the operation instructions operating on different data. In this case, herein, the one operation instruction (i.e., the operation instruction which is depended on by the other operation instruction) is called “dependency destination” and the other operation instruction (i.e., the operation instruction that depends on the one operation instruction) is called “dependency source”.

Further, a type of the data stored by the container C is not limited to a specific type. Namely, for example, figures, characters, character strings, document data, image data, moving picture data, voice data, any other electronic data, and any other various data may be retained or stored in the container C.

Further, the distributed key-value store can be performed using a known technique such as the DHT (Distributed Hash Table). Therefore, a detailed description of the distributed key-value store (e.g., how to specify the container C based on the key) is herein omitted.

The nodes are realized by one or more information processing apparatuses (i.e., computers) connected to each other via a network such as a LAN (Local Area Network) or the Internet. In this embodiment, the relationship between the “node” and the information processing apparatus is not limited to a one-to-one relationship. For example, the nodes (i.e., receptors R and containers C) illustrated in FIG. 1 are respective information processing apparatuses. Otherwise, for example, one information processing apparatus may be allocated to both the receptor R1 and the container C1; another information processing apparatus may be allocated to the container C2, and still another information processing apparatus is allocated to both the receptor R2 and the container C3.

Therefore, the information processing apparatus may serve as the receptor R or the container C depending on the operation instruction sequences. Namely, the information processing apparatus being served as the receptor R for a certain operation instruction sequence may serve as the container C for another operation instruction sequence. Further, the information processing apparatus may serve as both the receptor R and the container C for one operation instruction sequence.

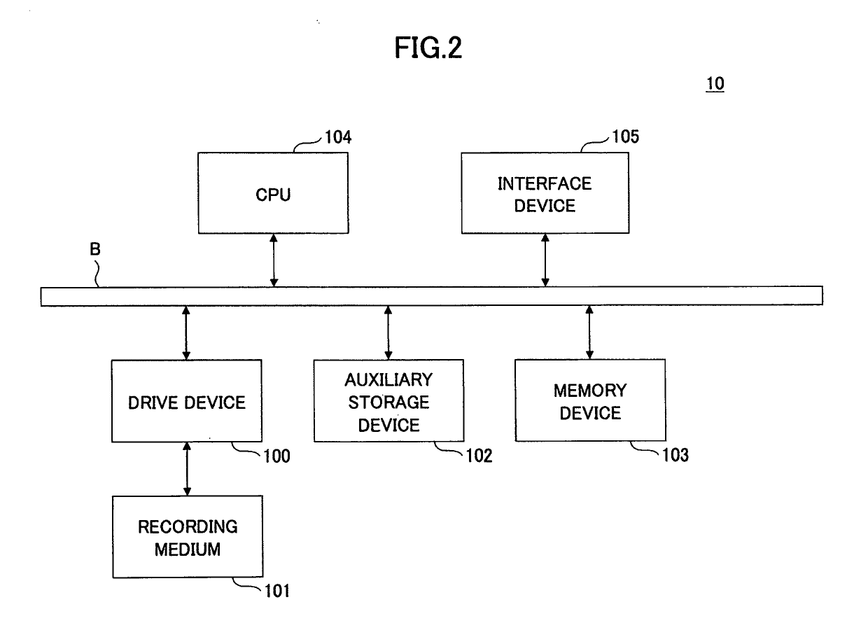

FIG. 2 illustrates an exemplary hardware configuration of the information processing apparatus according to an embodiment of the present invention. As illustrated in FIG. 2, an information processing apparatus 10 includes a drive device 100, an auxiliary storage device 102, a memory device 103, a CPU 104, and an interface device 105, which are connected to each other via a bus B.

A program for realizing the processes in the information processing apparatus 10 is provided using a recording medium 101 such as a CD-ROM. In this case, when the recording medium 101 storing a recorded program is set in the drive device 100, the program is installed from the recording medium 101 into the auxiliary storage device 102 via the drive device 100. However, the method of installing the program is not limited to this method using the recording medium 101. For example, the program may be downloaded from another computer via a network. The auxiliary storage device 102 stores not only the installed program but also necessary files, data and the like. Further, the auxiliary storage device 102 in the information processing apparatus 10 serving as the container C is functioning as the data store (i.e., data storage) in FIG. 1.

Upon a start-up instruction of the program, the memory device 103 reads out the program from the auxiliary storage device 102 and stores the program in the memory device 103. The CPU 104 executes the functions of the information processing apparatus 10 based on the program stored in the memory device 103. The interface device 105 is used as the interface to connect the information processing apparatus 10 to a network.

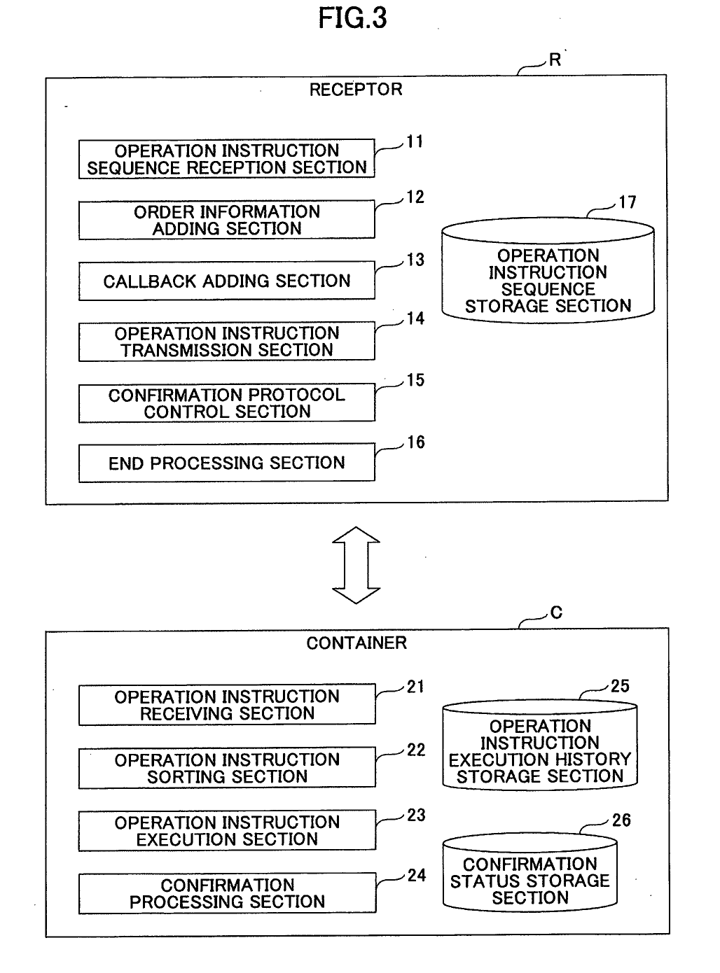

FIG. 3 illustrates exemplary functional configurations of the receptor R and the container C. As illustrated in FIG. 3, the receptor R includes an operation instruction sequence reception section 11, an order information adding section 12, a callback adding section 13, an operation instruction transmission section 14, a confirmation protocol control section 15, an end processing section 16, and an operation instruction sequence storage section 17. Those sections are realized by the processes executed by CPU 104 based on the program installed in the receptor R of the information processing apparatus 10.

The operation instruction sequence reception section 11 accepts an execution request for executing the operation instruction sequence. The execution request may be received from the other computer via a network or may be input by a user in the information processing apparatus 10 serving as the receptor R. In this embodiment, the other computer, the user and the like are called clients.

The order information adding section 12 adds a value (e.g., a number) to the operation instruction sequence relevant to the execution request, the value being unique among the operation instruction sequences and being used to identify order relationship in time domain (time sequential relationship). The term “unique among the operation instruction sequences” refers to unique in the information processing system 1 (i.e., the same value is not used among plural receptors). In this embodiment, the number is called “logical clock”. For example, the Lamport logical clock may be used as the logical clock in this embodiment. Details of Lamport logical clock are described in http://research.microsoft.com/en-us/um/lamport/pubs/time-clock.pdf.

Otherwise, the logical clock may be obtained (determined) by exchanging synchronous signals between the receptors R. In the synchronous signals, an ensured (confirmed) value of the logical clock is exchanged (transmitted). Specifically, for example, the receptor having ensured value “100” as the logical clock reports the ensured value “100” to another receptor R. By doing in this way, the information indicating up to which number (value) of the logical clock has been ensured can be shared among the receptors R. When the value of the logical clock is overlapped, the receptor R having a higher priority may use the value of the logical clock.

Further, the logical clock may be obtained (determined) by circulating a tag data having the current value of the logical clock among the plural receptors R along a path which passes through all the receptors R without passing through the same receptor again in one circulation. In this case, to ensure the logical clock, when receiving the tag data, the receptor R ensures the value of the tag data as the logical clock of the receptor R, increments the value of the tag data by one (1), and further circulates the tag data.

In this embodiment, the logical clock is used as the information indicating an order relationship of an execution order among the operation instruction sequences. The order information adding section 12 further adds information to each of the operation instructions, the information (hereinafter “operation instruction number”) indicating an order relationship among the operation instructions in one operation instruction sequence. The operation instruction number is unique in one operation instruction sequence.

Further, in this embodiment, the value of the logical clock and the operation instruction number are present within one data. The data is called a “time stamp”. Namely, in this embodiment, the time stamp including the value of the logical clock and the operation instruction number is added to each of the operation instructions by the order information adding section 12.

When there is an operation instruction that depends on the execution result of the other operation instruction, the callback adding section 13 adds (associates) a callback instruction to (with) the other operation instruction. As an example of the “operation instruction that depends on the execution result of the other operation instruction”, when the other operation instruction is an instruction acquiring data, the operation instruction uses the data acquired by the other operation instruction. Further, the callback instruction is a report instruction to report that the operation instruction to which the callback instruction is added is re-executed (executed again) when the operation instruction is re-executed. Namely, the container C having re-executed an operation instruction to which the callback instruction is added reports information to the other container C which is the dependency source of the operation instruction, the information indicating that the operation instruction is re-executed.

The operation instruction sequence storage section 17 stores the accepted operation instruction sequence using the auxiliary storage device 102 or the memory device 103.

The operation instruction transmission section 14 transmits (distributes) the operation instruction sequence to the container C storing data to be operated on in the operation instruction sequence.

The confirmation protocol control section 15 executes a process for realizing a scheme for sharing the information indicating whether confirmation up to which operation instruction is ensured. In this embodiment, this scheme is called a “confirmation protocol”. The term “the operation instruction sequence is confirmed” refers to that the execution of the operation instruction sequence is completed while the order relationship in the operation instruction sequence is ensured. The information indicating whether confirmation up to operation instruction sequence is ensured does not indicate which operation instruction sequence has been actually confirmed. The information indicates up to which operation instruction sequence that can be thought to be confirmed without risk. Further, in this embodiment, the term “confirmed” or “not confirmed” for the operation instruction sequence refers to that the operation instruction sequence is confirmed or is not confirmed based on the confirmation protocol.

The end processing section 16 determines the completion of the execution of the operation instruction sequence and executes a process in accordance with the determination. When all the operation instructions included in the operation instruction sequence are executed in proper order, the execution of the operation instruction sequence is completed. The execution of the operation instruction sequence may be completed regardless of the confirmation of the operation instruction sequence. This is because the operation instruction sequence may be ended regardless of the sequential order with another operation instruction sequence.

On the other hand, as illustrated in FIG. 3, the container C includes an operation instruction receiving section 21, an operation instruction sorting section 22, an operation instruction execution section 23, a confirmation processing section 24, an operation instruction execution history storage section 25, and a confirmation status storage section 26.

The operation instruction receiving section 21 receives the operation instruction distributed (transmitted) by the receptor R. The operation instruction sorting section 22 sorts (arranges) the newly received operation instruction and the operation instructions stored in the operation instruction execution history storage section 25 based on the respective time stamps data.

The operation instruction execution section 23 speculatively executes (speculative execution) the operation instructions using the data stored in the container C. The speculative execution of the operation instruction refers to the execution of the operation instruction regardless of the existence of the operation instruction that is to be executed in advance based on the time stamp data. Further, the operation instruction execution section 23 does not perform exclusive control (lock) on the data to be operated. By speculatively executing without exclusive control, it may become possible to improve the parallelism using plural containers C.

However, due to the speculative execution, the order relationship among the operation instructions may not be ensured (correctly maintained). Therefore, based on the sort result by the operation instruction sorting section 22, the operation instruction execution section 23 re-executes the operation instruction that is stored in the operation instruction execution history storage section 25 and that has been executed. Due to this re-execution, the inconsistency in the execution order of the operation instructions caused by the speculative execution is corrected. Further, the operation instruction execution section 23 executes the operation instructions one by one in a sequential manner. Therefore, a risk of occurrence of a problem caused by not executing the exclusive control may be avoided. Further, in this embodiment, the operation instructions are executed in a sequential manner. However, when the operation instruction sequence (e.g. transaction) is seen as a unit, the operation instruction sequence may be executed in a parallel manner.

By using the auxiliary storage device 102 or the memory device 103, the operation instruction execution history storage section 25 stores the newly received operation instruction and the operation instructions having already been executed in an order of the execution (i.e., in the order based on the time stamp data). Regarding data stored in the container C, the confirmation status storage section 26 stores a status (value) of the execution result of the confirmed operation instruction sequence using the auxiliary storage device 102 or the memory device 103.

The confirmation processing section 24 executes a confirmation process on the operation instruction sequence that is determined to be confirmed based on the confirmation protocol. For example, the confirmation processing section 24 deletes the operation instructions belonging to the operation instruction sequence from the operation instruction execution history storage section 25.

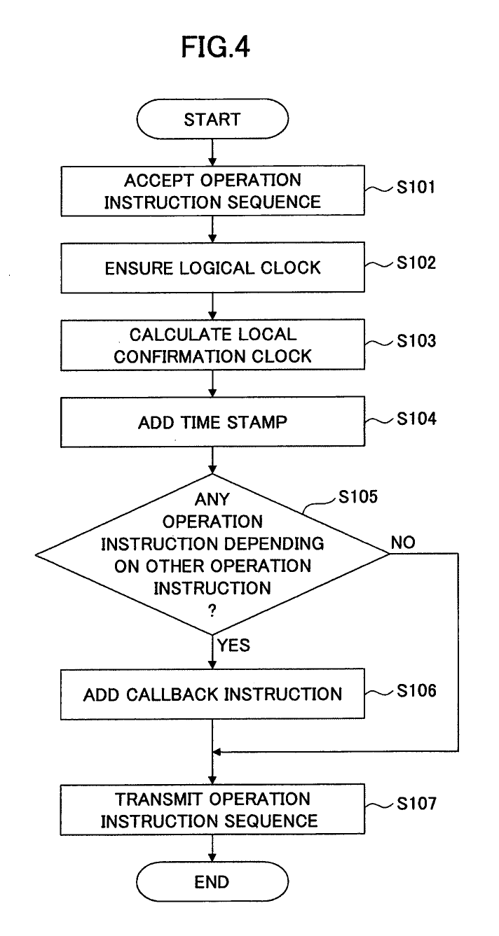

In the following, a processing procedure of the information processing system 1 is described. FIG. 4 is a flowchart illustrating a processing procedure performed by the receptor R upon the reception of the operation instruction sequence.

In step S101, the operation instruction sequence reception section 11 accepts the execution request for executing the operation instruction sequence. The operation instruction sequence reception section 11 stores the accepted operation instruction sequence in the operation instruction sequence storage section 17.

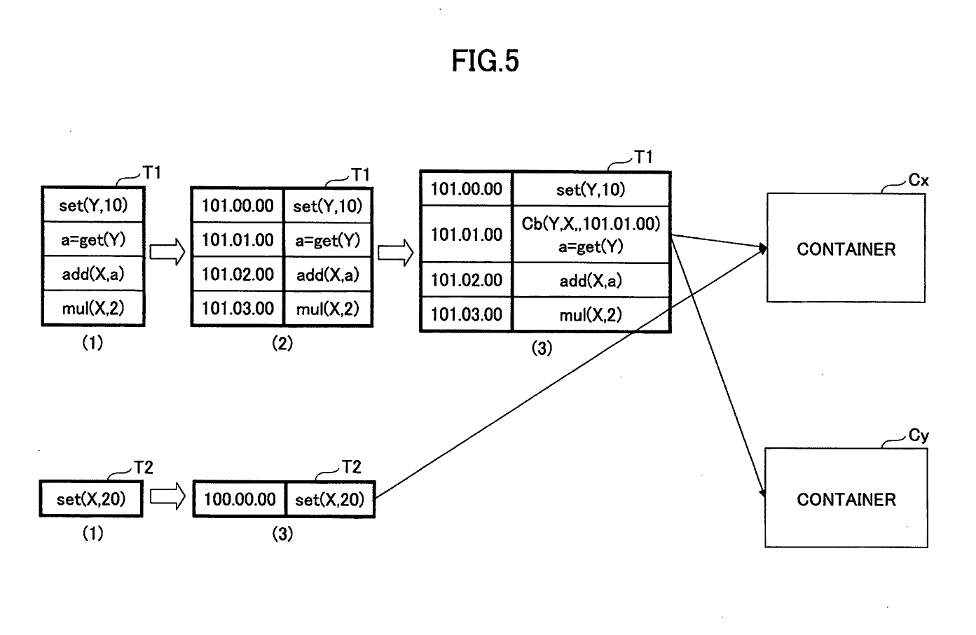

FIG. 5 illustrates an example of transitions of the operation instruction sequences as the processes proceed. Specifically, FIG. 5 illustrates an example of transitions of two operation instruction sequences T1 and T2 as the processes in FIG. 4 proceed. First, the transitions of the operation instruction sequence T1 are described. Namely, a case is described when the operation instruction sequence T1 is accepted. For example, a status of the operation instruction sequence T1 upon being accepted is described in state (1) of FIG. 5. In state (2), the operation instruction sequence T1 includes four operation instructions: set(Y,10), a=get(Y), add(X,a), and mul(X,2). The operation instruction set(Y,10) denotes that a value “10” is set in data Y. The operation instruction a=get(Y) denotes that a value of data Y is acquired and then the acquired value is assigned to a value “a”. The operation instruction add(X,a) denotes that the value “a” is added to the data X to create new data X. The operation instruction mul(X,2) denotes that 2 is multiplied with the data X.

As obvious from the above, in this embodiment, the operation instructions are expressed in the following format.

Operation instruction name (argument ▪▪▪)

Basically, the first argument is an identifier (data name) of the data to be operated on. When the second argument is provided, the second argument is a value applied to a data by the operation instruction, the data being identified by the first argument.

Next, the order information adding section 12 acquires (ensures) a logical clock (i.e., the number that is ensured to be unique among the plural receptors R) and assigns the acquired logical clock to the operation instruction sequence T1 (step S102).

Next, the confirmation protocol control section 15 calculates a value of a local confirmation clock (step S103). The local confirmation clock refers to a value of the confirmed logical clock for the operation instruction sequence estimated by one receptor R. The local confirmation clock is calculated based on the following formula.

Min.(value of logical clock assigned to operation instruction sequence stored in operation instruction sequence storage section 17)−1

For example, it is assumed that three operation instruction sequences stored in one receptor R have values of the logical clock 100, 101, and 103. In this case, the minimum value is 100. Therefore, the local confirmation clock of the receptor R is obtained based on the formula 100−1=99. Namely, the receptor R estimates that the operation instruction sequences to which any of the values equal to or less than 99 is assigned as the logical clock have been confirmed. As described below, the local confirmation clock is used for realizing the confirmation protocol.

Next, the order information adding section 12 adds the time stamp to the operation instructions included in the operation instruction sequence T1 (step S104). As a result, the status of the operation instruction sequence T1 is transitioned to status (2) in FIG. 5. In status (2) of FIG. 5, values added to the left column in the operation instructions are time stamp data.

In this embodiment, the time stamp is expressed based on the following format. <logical clock>.<operation instruction number>.<re-execution times> (as illustrated in status (2) of FIG. 5)

Namely, the time stamp is expressed using three (3) hierarchies of concepts which are divided by a comma. However, this format is one example only. For example, those hierarchies of concepts may be divided by any dividing mark other than a comma. Further, when the number of digits of each of the hierarchies of concepts is fixed (known), any dividing mark including a comma may be eliminated. Further, the arranging order of those hierarchies of concepts may be changed.

As the logical clock, for the operation instructions belonging to the same operation instruction sequence, the same value as added (assigned) to the operation instruction sequence is added (assigned). Namely, the values of the logical clock included in the time stamp of the operation instructions belonging to the same operation instruction sequence are the same as each other. In FIG. 5, a case is illustrated where the operation instructions belonging to the same operation instruction sequence T1 have the same logical clock value “101”.

The operation instruction number is a value indicating the execution order of the operation instructions in the operation instruction sequence. Therefore, each operation instruction has a unique value in the same operation instruction sequence. In FIG. 5, a case is illustrated where values 00 through 03 are sequentially assigned to the operation instructions. Further, values which are unique within one receptor R may be assigned as the operation instruction number. For example, in one receptor R, values 00 through 04 are assigned to the operation instructions included in one operation instruction sequence, and values from 05 are assigned to the operation instructions included in another operation instruction sequence.

The re-execution times is a number of re-execution times of the operation instruction. For example, the initial value of the re-execution times is “00”, and the re-execution times is incremented whenever the operation instruction is re-executed.

Next, the callback adding section 13 determines whether there is an operation instruction depending on the execution result of another operation instruction in the operation instruction sequence T1 (step S105). In the operation instruction sequence T1 of FIG. 5, the second argument “a” of “add(X,a)” is the execution result of “a=get(Y)”. Therefore, “add(X,a)” depends on the execution result of “a=get(Y)”. This is because the result of “add(X,a)” depends on the value of “a”.

More specifically, in a case of this embodiment, the callback adding section 13 determines whether there is an operation instruction having an argument including a variable storing the execution result of the other operation instruction. When such an operation instruction is detected, it is determined that the operation instruction depends on the execution result of the other operation instruction. However, the determination method may be appropriately changed (selected) depending on, for example, the notation of the operation instruction.

When determining that there is the operation instruction depending on the execution result of the other operation instruction (YES in step S105), the callback adding section 13 adds a callback instruction to the operation instruction (dependency destination) that is depended on (step S106). As a result, the status of the operation instruction sequence T1 becomes as illustrated in status (3) of FIG. 5.

In the relationship between “add(X,a)” and “a=get(Y)”, “add(X,a)” is specified as the dependency source and “a=get(Y)” is specified as the dependency destination. Therefore, in status (3) of FIG. 5, a callback instruction (i.e., “Cb(Y,,101.01.00)”) is added to “a=get(Y)”. Namely, in this embodiment, it is assumed that the callback instruction is expressed in the following format.

Cb(<data name of dependency destination>,<data name of dependency source>, ▪▪▪, <time stamp of operation instruction starting re-execution in response to callback instruction>)

In this embodiment, the operation instruction name of the callback instruction is expressed as “Cb”.

The <data name of dependency destination> as the first argument is the data name of the data to be operated on in the operation instruction of the dependency destination. Practically, the data name is the identification information of the container C executing the operation instruction of the dependency destination.

The <data name of dependency source> as the second argument is the data name of the data to be operated on in the operation instruction of the dependency source. Practically, the data name is the identification information of the container C executing the operation instruction of the dependency source.

The dependency relationship between the operation instructions is equivalent to the dependency relationship between the data to be operated by the operation instructions. This is because when the status of the data related to the data name of the dependency destination is changed, the status of the data related to the data name of the dependency source is influenced. Therefore, in the above format, such expressions <data name of dependency destination> and <data name of dependency source> are used. Further, there may be more than one data of the dependency sources. For example, in the operation instruction sequence T1, when an operation instruction “add(Z,a)” is included after “a=get(Y)”, data Z also depends on data Y. Therefore, more than one argument may be designated for data names of the dependency sources.

The last argument <time stamp of operation instruction starting re-execution in response to callback instruction> refers to the time stamp of the operation instruction to which the callback instruction is added. Namely, in this case, the last argument refers to the time stamp added to the operation instruction “a=get(Y)”.

Next, the operation instruction transmission section 14 adds the identification information of the receptor R to the operation instruction sequence T1, and then transmits the operation instruction sequence T1 to the container C storing the data determined to be operated on in the operation instruction sequence T1 (step S107). As the identification information of the receptor R, any information that can be used to identify the receptor by the container C in the network communications may be used. The container C storing the data determined to be operated on in the operation instruction sequence T1 refers to the container C storing the data to be operated by any of the operation instructions included in the operation instruction sequence T1. Therefore, for example, when one operation instruction sequence includes one or more operation instructions operating on data different from each other, plural containers C may be the destinations of the transmission of the operation instruction sequence T1. In this case of FIG. 5, the operation instruction sequence T1 includes the operation instruction operating data Y and the operation instruction operating data X. Therefore, the operation instruction sequence T1 is transmitted to both the container Cx storing data X and the container Cy storing data Y.

However, the operation instruction transmission section 14 may transmit the operation instruction sequence to only the container C that stores data to be operated by a first operation instruction in the operation instruction sequence. In this case, the operation instruction sequence may be transmitted between the containers C related to the operation instruction sequence. Specifically, when one container C having received the operation instruction sequence detects the operation instruction that is to operate on data that is not stored in the container C, the container C transfers the operation instruction sequence to the other container C storing the data. For example, in the case of the operation instruction sequence T1, the receptor R transmits the operation instruction sequence T1 to the container Cy. Then, when the container Cy detects the instruction operation “add(X, a)”, the container Cy transfers the operation instruction sequence T1 to the container Cx.

Further, when the receptor R transmits the operation instruction sequence to the containers C, it is not always necessary to transmits all of the operation instructions included in the operation instruction sequence to the containers C. Namely, in this case, only the operation instruction relevant to the container C may be transmitted to the container C. Further, in this case, the receptor R may transmit the operation instructions one by one to the container C. Otherwise, the receptor R may collectively transmit all the operation instructions relevant to the container C to the container C.

In this embodiment, the container C storing data is uniquely identified based on the data name of the data. Further, the data name of the data to be operated by the operation instruction is designated in the first argument of the operation instruction. Therefore, based on the first argument of the operation instruction, the operation instruction transmission section 14 or the containers C determine the container C to which the operation instruction sequence is to be transmitted.

Further, the contents (instance) of the operation instruction sequence T1 in status (3) of FIG. 5 are maintained in the operation instruction sequence storage section 17 at least until the completion of the execution of the operation instruction sequence T1. Therefore, in the operation instruction sequence storage section 17, plural operation instruction sequences may be stored.

On the other hand, in FIG. 5, the other operation instruction sequence T2 is also illustrated. The status (1) of the operation instruction sequence T2 indicates the status when the receptor R accepts the operation instruction sequence T2. The status (2) of the operation instruction sequence T2 indicates the status when the time stamp is added to the operation instruction of the operation instruction sequence T2. In this case of FIG. 5, the first value of the time stamp of the operation instruction of the operation instruction sequence T2 is “100”. Namely, the value of the logical clock for the operation instruction sequence T2 is “100”. In this embodiment, it is assumed that the minimum value of the logical clock is “0”, and that the value of the logical clock is incremented as time elapses (as the logical clock is ensured (acquired)). Therefore, it is understood that the operation instruction sequence T2 is accepted before the operation instruction sequence T1 is accepted by the receptor R. In this case, the receptor R that accepts the operation instruction sequence T2 and the receptor R that accepts the operation instruction sequence T1 may be the same node or different nodes. The operation instruction sequence T2 includes only “set(X,20)” operating the data X. Therefore, the operation instruction sequence T2 is transmitted to container Cx.

As described above, in the information processing system 1, typically, the operation instruction sequences are asynchronously transmitted from the plural receptors R to the containers C.

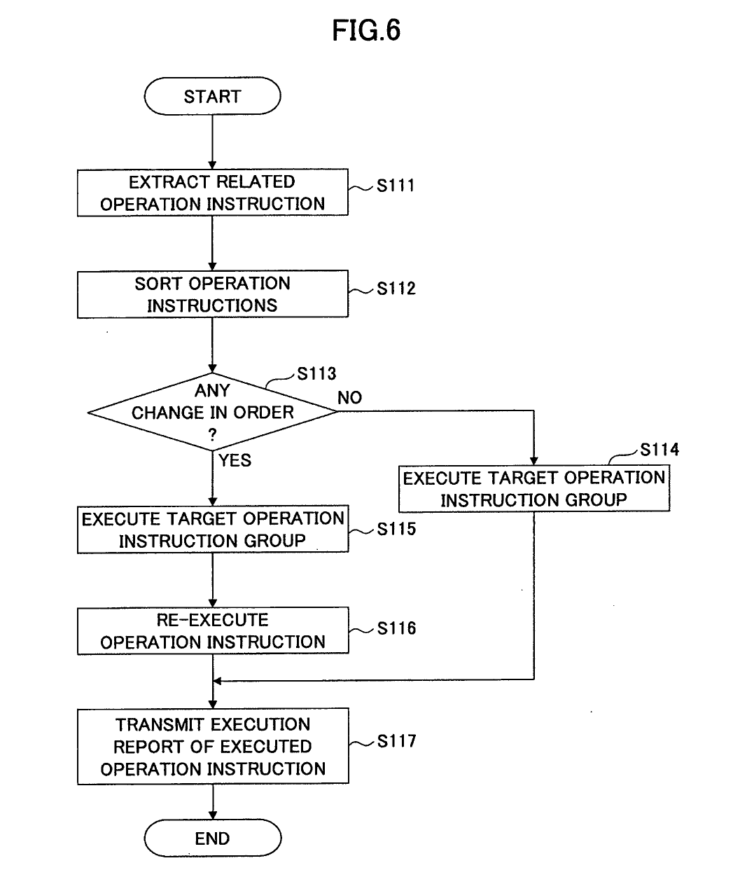

Next, a processing procedure performed by the container C is described. FIG. 6 is a flowchart illustrating the processing procedure of the container C upon the receipt of the operation instruction sequence.

The operation instruction receiving section 21 of the container C waits for the receipt of the operation instruction sequence. Upon the receipt of the operation instruction sequence, the operation instruction receiving section 21 extracts the operation instruction relevant to the container C from the received operation instruction sequence (step S111). The operation instruction relevant to the container C refers to the operation instruction that is to operate on the data stored in the container C. More specifically, the operation instruction relevant to the container C refers to the operation instruction in which the data name of the data stored in the container C is designated in the first argument of the operation instruction.

For example, in a case where the container Cx in FIG. 5 receives the operation instruction sequence T1, the operation instructions “add(X,a)” and “mul(X,2)” correspond to the operation instructions relevant to the container Cx. Further, the operation instruction to which the callback instruction is added and in which data name of the data stored in the container is designated in the second or later argument as the data name of the dependency source is also regarded as the operation instruction relevant to the container C. For example, when the container Cx in FIG. 5 receives the operation instruction sequence T1, the instruction operation “a=get(Y)” corresponds to the instruction operation relevant to the container Cx. In the following, one or more operation instructions extracted as described above may be called “a target operation instruction group”.

Further, when the receptor R can transmit the operation instructions only to the container C storing data to be operated by the operation instructions, it may not be necessary for the container C to perform the extraction process as described above. Further, when the operation instructions are separately transmitted one by one from the receptor R, the term “target operation instruction group” may be replaced by the term “received one operation instruction” in the processing procedure described below.

Next, the operation instruction sorting section 22 sorts the target operation instruction group and the operation instructions already stored in the operation instruction execution history storage section 25 in an ascending order based on the time stamp data added to the target operation instruction group and the operation instructions, and updates the data of the operation instruction execution history storage section 25 based on the sort result (step S112). Namely, the sort result is stored in the operation instruction execution history storage section 25. In this case, the operation instruction sequence to which the operation instructions already stored in the operation instruction execution history storage section 25 belong is different from the operation instruction sequence to which the target operation instruction group belongs. Therefore, the sort may be performed across the operation instruction sequences.

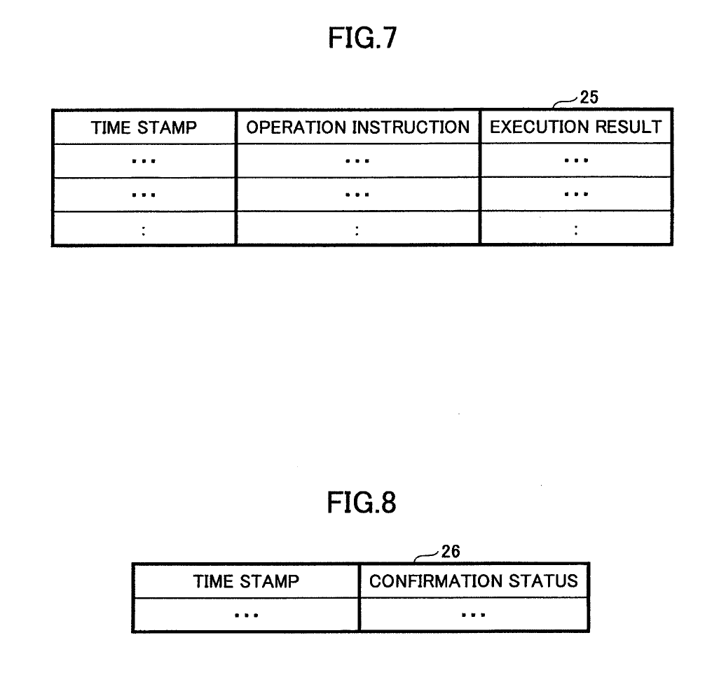

FIG. 7 illustrates an exemplary configuration of the operation instruction execution history storage section 25 of FIG. 3. As illustrated in FIG. 7, the operation instruction execution history storage section 25 includes the time stamp data, the operation instructions, and the execution result of the operation instructions for each of the “not confirmed” operation instruction sequences. The execution result refers to a state (result) after the operation instruction is executed using the data stored in the container C. When the operation instruction execution history storage section 25 is updated due to the sort result, a null value (no data) may be input (stored) in the column of the execution result for the operation instruction included in the target operation instruction group. Further, in the sort based on the time stamp, the values of the logical clock are compared first. When the values of the logical clock are the same, the values of the operation instruction number are compared next. Therefore, in the sorting order, it does not occur that the operation instruction belonging to one operation instruction sequence is interrupted (arranged) in between the operation instructions belonging to the other operation instruction sequence. Further, in this embodiment, it is assumed that each container has one data. Therefore, in the operation instruction execution history storage section 25, the container and the data have a one-to-one relationship.

Next, the operation instruction execution section 23 determines whether the order of the operation instructions having been executed has been changed (step S113). Namely, among the operation instructions having been executed, it is determined whether there is an operation instruction having a time stamp data later than the time stamp data of the target operation instruction group.

When determining that there is no such operation instruction (NO in step S113), the operation instruction execution section 23 speculatively executes the operation instructions included in the target operation instruction group in accordance with the order of the operation instruction number (step S114). The operation instruction execution section 23 stores the execution results of the operation instructions in the operation instruction execution history storage section 25.

For example, a case where the target operation instruction group is arranged at the end as the result of the sort or a case where when the operation instruction execution history storage section 25 has a null value (no data) upon the reception of the target operation instruction group corresponds to the above case (NO in step S113). The reason for using the term “speculatively” is that whether the operation instruction sequence having the time stamp value later than the time stamp value of the target operation instruction group is to be received later is not known (uncertain) at this timing. Further, the another reason for using the term “speculatively” is that, at this timing, the execution order of the operation instructions belonging to the operation instruction sequence of the target operation instruction group of the container C and the operation instructions to be executed in the other container C is not yet determined at this timing.

Further, the execution targets of the operation instructions are the data stored in the data store (data storage). Namely, even in the speculative execution, so-called master data are directly operated on.

On the other hand, when determining that there is such an operation instruction (YES in step S113), first, the operation instruction execution section 23 speculatively executes the operation instructions included in the target operation instruction group (step S115). The operation instruction execution section 23 stores the execution results of the operations instructions in the operation instruction execution history storage section 25. In this case, the operation target of the first operation instruction in the target operation instruction group corresponds to the execution result stored in the operation instruction execution history storage section 25 for the previous operation instruction in the sorting order. However, when the target operation instruction group is arranged in the beginning in the sorting order, the data stored in the confirmation status storage section 26 is the operation target of the operation instruction. The operation targets of the second or later operation instructions of the received operation instructions are the data stored in the data store.

FIG. 8 illustrates an exemplary configuration of the confirmation state storage section 26 in FIG. 3. As illustrated in FIG. 8, the confirmation state storage section 26 stores the time stamp (logical clock) of the finally confirmed operation instruction sequence and data status (confirmed status) of the operation instruction sequence after the execution of the operation instruction sequence.

In step S115, the data in the data store is not the operation target of the first operation instruction. This is because the status of this data is based on the status obtained as the execution result of the operations instructions executed in incorrect execution order. Further, the execution results of the operation instructions in step S115 are influenced to the data store.

Next, the operation instruction execution section 23 executes the operation instructions having the time stamp value later than the time stamp value of the target operation instruction group based on the order stored in the operation instruction execution history storage section 25 (i.e., based on the order of the time stamp values) (step S116). Namely, the operation instructions are re-executed (executed again), the operation instructions having the time stamp value later than the time stamp value of the target operation instruction group. In the re-execution, the operation targets are the data stored in the data store. Further, whenever the operation instruction is executed, the execution result is stored in the data store. Further, the operation instruction execution section 23 increments the value of the re-execution times in the time stamp of the re-executed operation instruction. Namely, the value of the re-execution times is incremented by one (1).

Further, in steps S114, S115, or S116, the execution request is transmitted to the container C corresponding to the operation instruction to which the callback instruction is added and in which the data name of the name stored in the container C is designated in the second or later argument of the callback instruction as the data name of the dependency source. For example, the operation instruction execution section 23 of the container Cx in FIG. 5 transmits the execution request of “a=get(Y)” to the container Cy. Upon the reception of the execution request, the container Cy executes the processes as illustrated in FIG. 6. The operation instruction execution section 23 of the container Cx substitutes a value for “a”, the value being transmitted from the container Cy in response to the execution request, and then executes the operation instruction “add(X,a)” and further operation instructions.

However, instead of waiting for the receipt of the execution result of the dependency destination (e.g., “a=get(Y)”), the operation instructions after the dependency destination may be executed. In this case, until the receipt of the execution result of the dependency destination, the execution of the dependency source (e.g., add(X,a)) including an uncertain (incorrect) value in the argument may not be excluded (i.e., ignored) and the subsequence operation instructions may be executed.

The reason why the operation instruction of the dependency source can be ignored is that even if the operation instruction of the dependency source is ignored, due to the execution of the callback instruction described below, the operation instruction of the dependency source is to be executed. Otherwise, after the receipt of the execution result of the dependency destination, the operation instruction of the dependency source may be executed, and the operation instructions may be re-executed from the subsequent operation instruction of the dependency source.

After step S114 or S116, the operation instruction execution section 23 designates the time stamp value of the executed operation instructions, and transmits execution reports of the operation instructions to the respective receptors R having transmitted the operation instructions (step S117). The execution report includes, for example, information indicating whether the execution is successful. Further, the execution report may include the data obtained as the execution result. The receptor R having transmitted the operation instruction may determine based on the identification information of the receptor, the identification information being added to the operation instruction sequence. Further, the execution report of the instruction that has not been executed is not transmitted. Further, the execution report of the operation instruction having transmitted the execution result to the other container such as the operation instruction of the dependency destination is not transmitted as well. This is because the execution request of such an operation instruction is transmitted from the other container C. Further, the execution report of the operation instruction is executed based on the execution request (call) from the other container C. The “operation instruction executed based on the execution request (call) from the other container C” refers to the operation instruction such as “a=get(Y)” that is executed in container Cy in response to the execution request (call) from the other container C. If the execution report of the operation instruction executed in response to the call from the other container C is transmitted to the receptor R, it may become difficult for the receptor R to determine whether the execution of the operation instruction sequence including the operation instruction has completed while the execution order is correctly maintained. Therefore, the execution report of the operation instruction “a=get(Y)” is transmitted from the container Cy to the receptor R upon the execution in the container Cy in response to the receipt of the operation instruction sequence T1 by the container Cy.

Further, in the above description, an example is described where the operation instruction execution history storage section 25 can store the execution results of the operation instructions. However, the operation instruction execution history storage section 25 may not store the execution results of the operation instructions. In this case, whenever a new operation instruction is received, all the operation instructions stored in the operation instruction execution history storage section 25 are executed based on the sorting order. As the operation target of the first operation instruction, the data of the confirmed status recorded in the confirmation state storage section 26 is used. Further, as the operation targets of the second or later operator instructions, the data recorded in the data store are used.

Next, a process based on the callback instruction (callback process) is described. First, the purpose of the callback process is described.

For example, in FIG. 5, the container Cx storing data X executes the operation instructions “add(X,a)” and “mul(X,2)” of the operation instruction sequence T1. Further, the container Cx transmits the execution request for executing the operation instruction “a=get(Y)” to the container Cy. This is because that “a=get(Y)” is the operation instruction of the dependency destination of the operation instruction “add(X,a)” executed by the container Cx.

On the other hand, the container storing data Y executes the operation instructions “set(Y,10)” and “a=get(Y)” of the operation instruction sequence T1.

In this case, there is a possibility that the container Cx transmits the execution request for executing “a=get(Y)” to the container Cy before the container Cy executes the operation instruction “set(Y,10)”. If, in the container Cy, the value (status) of Y before the execution of “set(Y,10)” is “20”, the operation instruction “add(X,a)” and the subsequent processes (operation instructions) are executed while assuming that a=20 in the container Cx. After that, when the operation instruction “set(Y, 10)” is executed in the container Cy, the execution of all of the operation instructions included in the operation instruction sequence T1 have been completed while the correct order is not ensured (maintained) in the operation instruction sequence T1. As a result, the execution result of the operation instruction sequence T1 becomes incorrect. The callback process in this embodiment is provided so as to prevent the occurrence of the above problem.

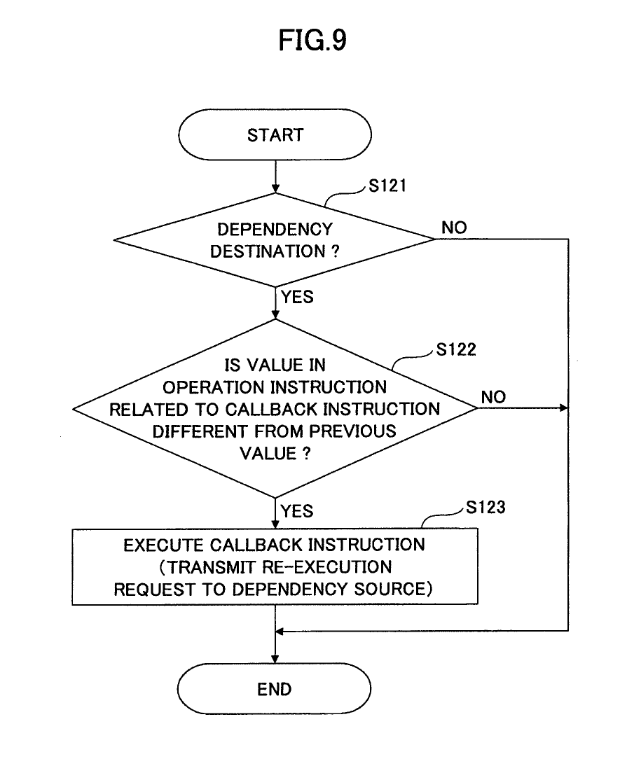

FIG. 9 is a flowchart illustrating a processing procedure performed by the container of the dependence source in the callback process. When the operation instruction to which the callback instruction is added is re-executed, this process in FIG. 9 is performed by the container C that re-executes the operation instruction.

In step S121, after re-executing the operation instruction to which the callback instruction is added, the operation instruction execution section 23 determines whether the container C corresponds to the dependency destination. Specifically, it is determined whether the container C stores data relevant to the data name designated in the first argument of the callback instruction.

When determining that the container C corresponds to the dependency destination (YES in step S121), the operation instruction execution section 23 further determines whether the execution result of the re-execution of the operation instruction to which the callback instruction is added differs from the previous execution result (step S122). The previous execution result refers to the execution result already stored in the operation instruction execution history storage section 25 regarding the operation instruction before the re-execution of the operation instruction.

For example, it is assumed that in response to the execution request for executing the operation instruction “a=get(Y)” from the container Cx, the container Cy executes the operation instruction, and then, the container Cy receives the operation instruction sequence T1. In this case, the value (result) of the execution of “a=get(Y)” in response to the receipt of the operation instruction sequence T1 may differ from the previous value (result). This is because in a case where “a=get(Y)” is executed in response to the receipt of the operation instruction sequence T1, “set(Y,10)” is executed before the execution of “a=get(Y)”.

When determining that the execution results are different from each other (YES in step S122), the operation instruction execution section 23 executes the callback instruction added to the operation instruction (step S123). Specifically, the operation instruction execution section 23 transmits a re-execution request for re-executing the operation instruction by designating a value of the last argument in the callback instruction to the container C relevant to the data name designated in the second or later argument in the callback instruction. The re-execution request corresponds to a report (request) for re-executing the instruction added in the callback instruction. In this embodiment, the last argument in the callback instruction is the time stamp of the operation instruction to which the callback instruction is added. Therefore, the re-execution request corresponds to the re-execution request for re-executing the operation instruction to which the callback instruction is added. More specifically, when the callback instruction is given as “Cb(Y,X,101.01.00)”, the re-execution request for re-executing the operation instructions having the time stamp value equal to or later than “101.01.00” is transmitted to the container Cx.

Further, in the case where the operation instruction execution history storage section 25 does not store the execution result of the operation instruction, whenever the operation instruction to which the callback instruction is added is executed, the callback instruction is executed without comparing the execution result with the previous execution result. Further, in this case, when the operation instruction to which the callback instruction is added is executed for the first time, the callback instruction may not be executed. However, as in this embodiment, by executing the callback instruction when the execution result of the operation instruction to which the callback instruction is added differs from the previous execution result of the operation instruction, it may become possible to reduce the processing load of the container C and the communication traffic.

Further, in the case where there is a possibility that the other operation instruction is executed without waiting for the receipt of execution result of the operation instruction of the dependency destination, the callback instruction may be executed whenever the operation instruction to which the callback instruction is added is executed. In this case, even when the operation instruction to which the callback instruction is added is executed for the first time, the callback instruction may be executed. This is because if the operation instruction to which the callback instruction is added is not re-executed, the value of the argument of the operation instruction of the dependency source may become uncertain (incorrect).

Next, the processes executed by the container C are described, the container C having received the re-execution request transmitted from the other container C in response to the execution of the callback instruction.

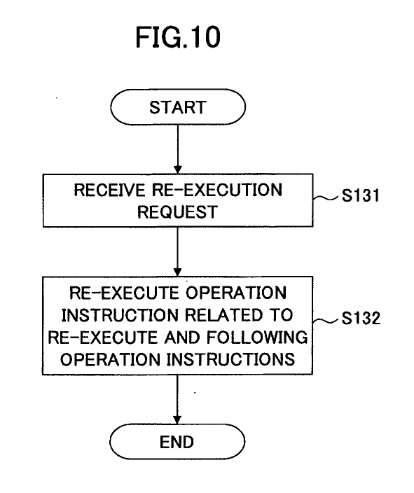

FIG. 10 is a flowchart illustrating a processing procedure performed by the container relevant the dependence source in the callback process.

In the container C of to the dependence source, upon the receipt of the re-execution request in response to the callback instruction (step S131), the operation instruction transmission section 14 of the container C re-executes the operation instructions that are stored in the operation instruction execution history storage section 25 and that have the time stamp value equal to or later than the time stamp value designated in the re-execution request (step S132). The execution process in step S132 is similar to that in step S116 in FIG. 6.

For example, in the container Cx in FIG. 5, upon the receipt of the re-execution request based on the callback instruction “Cb(Y,X,101.01.00)”, the execution request for executing “a=get(Y)” is transmitted to the container Cy, and the operation instructions “add(X,a)” and “mul(X,2)” are executed in the container Cx. In step S132, preferably, after the execution result of “a=get(Y)” is transmitted (i.e., after the value “a” is clarified), the specific value is substituted for “a”, and the execution request for executing “add(X,a)” is transmitted. Namely, it is preferable that based on the execution result of the operation instruction of the dependency destination, the execution request for executing the operation instruction of the dependency source is transmitted.

Further, in the case where the operation instruction corresponding to the time stamp designated in the re-execution request is not stored in the operation instruction execution history storage section 25, the re-execution request may be ignored. Such status may occur in the container C when the operation instruction sequence including the operation instruction of the destination source is not received. In this case, by executing the operation instruction of the destination source corresponding to the receipt of the operation instruction the container C, the order relationship of the operations instructions in the same operation instruction sequence is correctly maintained.

Next, the processes executed by the receptor R are described, the receptor R having received the execution report transmitted in step S117 in FIG. 6.

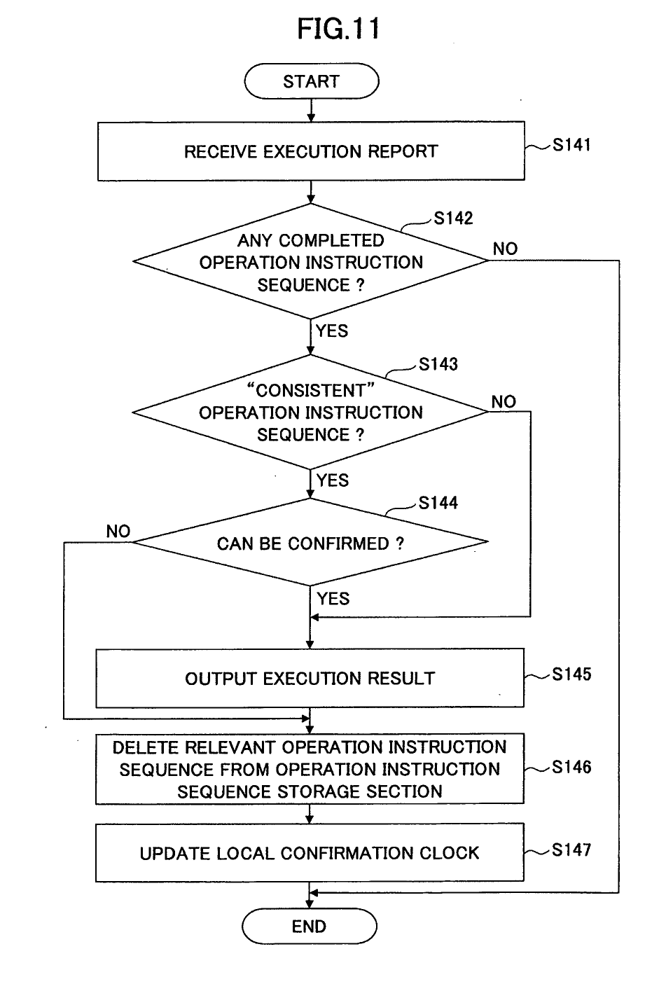

FIG. 11 is a flowchart illustrating a processing procedure performed by the receptor R in response to the execution report.

Upon the receipt of the execution report by the receptor R, the end processing section 16 of the receptor R stores information indicating that the execution of the operation instruction relevant to the time stamp designated in the execution report has completed (step S141). In this case, for example, the information indicating the execution of the operation instruction is completed is added to the operation instruction of the operation instruction sequence stored in the operation instruction sequence storage section 17.

Next, the end processing section 16 determines whether there is the operation instruction sequence stored in the operation instruction sequence storage section 17 and in which the execution of all operation instructions in the operation instruction sequence has been completed (step S142). When determining that there is the operation instruction sequence in which the execution of all operation instructions in the operation instruction sequence has been completed (YES in step S142), the end processing section 16 further determines whether the operation instruction sequence is consistent (step S143). Whether the operation instruction sequence is consistent is determined by the client. Namely, in accepting the operation instruction sequence in step S101 in FIG. 4, whether the operation instruction sequence is consistent or eventual is designated as one of the attribute information items of the operation instruction sequence. Further, the attribute information item includes, for example, client identification information.

When determining that the operation instruction sequence is consistent (YES in step S143), the end processing section 16 further determines whether the operation instruction sequence can be confirmed based on the confirmation protocol (step S144). This determination practically corresponds to the determination whether the execution result of the operation instruction sequence can be output. Namely, regarding the consistent operation instruction sequence, the output timing of the execution result is determined based on the confirmation protocol.

When determining that the operation instruction sequence can be confirmed (YES in step S144), the end processing section 16 outputs the execution result of the operation instruction sequence to the client (step S145). The output of the execution result is performed in various manners such as the transmission via a network, display on the display device, or the like. Further, the execution result includes various information items such as information indicating whether the execution is successful, and data (if the operation instruction sequence requests the client to review the data). The client to which the execution result is output is determined based on the client identification information included in the attribution information of the operation instruction sequence. On the other hand, when determining that the operation instruction sequence is not confirmed (NO in step S144), the end processing section 16 does not output the execution result of the operation instruction sequence.

On the other hand, when determining that the operation instruction sequence is eventual (NO in step S143), the end processing section 16 outputs the execution result of the operation instruction sequence without determining whether the operation instruction sequence can be confirmed (step S145).

Next, the end processing section 16 deletes the operation instruction sequence from the operation instruction sequence storage section 17 (step S146). In response to the deletion of the operation instruction sequence from the operation instruction sequence storage section 17, the confirmation protocol control section 15 updates the local confirmation clock of the receptor R (step S147). Namely, a value determined by subtracting one (1) from the minimum value of the logical clock corresponding to the operation instructions stored in the operation instruction sequence storage section 17 at this time is a new local logical clock.

Next, the confirmation protocol is described. As described above, the receptors manage their own local confirmation clocks. In the confirmation protocol, the receptors R determine a confirmation clock of the entire information processing system 1 (hereinafter referred to as “global confirmation clock”) by exchanging the local confirmation clocks with each other. However, it may be noted that, due to the difference in timing of acquiring the local confirmation clocks of the other receptors R, the receptors R may have different values of the global confirmation clock.

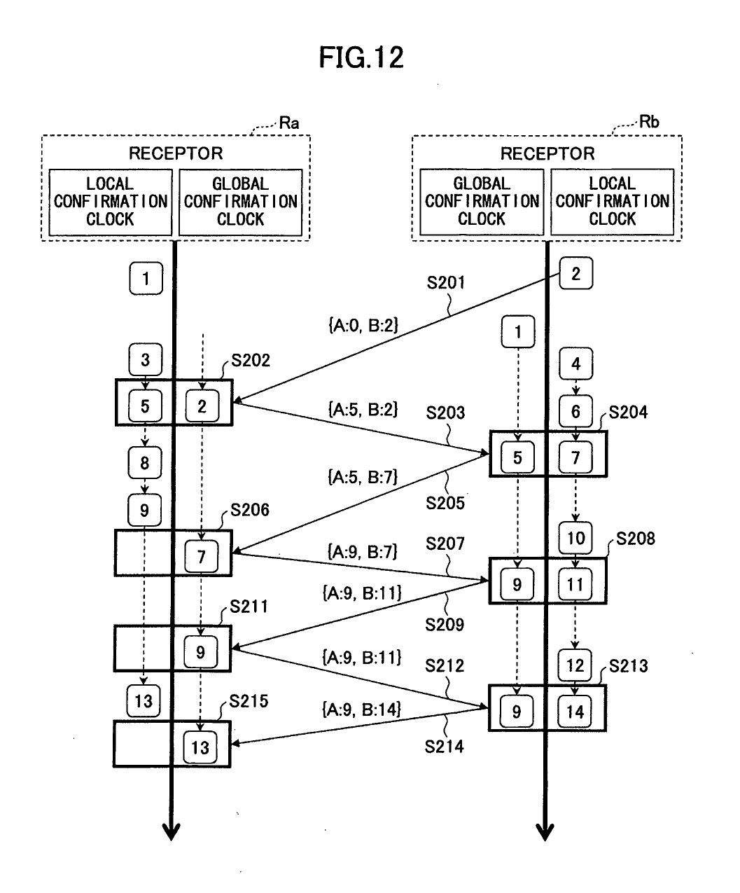

FIG. 12 is an example of a sequence diagram of the confirmation protocol. FIG. 12 illustrates the transitions of the values of the local confirmation clocks of the receptors Ra and Rb and the value of the global confirmation clock as time elapses. In the initial status in FIG. 12, it is assumed that the receptors Ra and Rb do not know each other's local confirmation clocks.

For example, in step S201, the confirmation protocol control section 15 of the receptor Rb transmits the local confirmation clock list (hereinafter referred to as “logic clock list”) to the receptor Ra, the logic clock list including the local confirmation clocks of the receptors Ra and Rb. The notation “{A:0,B:2}” denotes that the values of the local confirmation clocks of the receptors Ra and Tb are “0” and “2”, respectively. The value “0” is used as the value of the local confirmation clock of the receptor Ra because the receptor Rb does not know the value of the local confirmation clock of the receptor Ra. Therefore, any value (e.g., “−1”) other than “0” may alternatively used.

Upon the receipt of the logic clock list, the confirmation protocol control section 15 of the receptor Ra updates the logic clock list based on the local confirmation clock of the receptor Ra and the received logic clock list, and obtains the global confirmation clock based on the current local confirmation clock of the receptor Ra and the local confirmation clock of the receptor Rb included in the logic clock list (step S202). Specifically, the minimum value of the local confirmation clocks included in the updated logic clock list is determined as the value of the global confirmation clock. In step S202, the local confirmation clock of the receptor Ra is “5”. Therefore, the minimum value “2” from among the values “5” and “2” is determined as the global confirmation clock.

Further, the local confirmation clocks of the receptors R are updated upon the receipt of the operation instruction sequence, the end of the operation instruction sequence and the like and asynchronously with the exchange of the logic clock list.

Next, the confirmation protocol control section 15 of the receptor Ra transmits the logic clock list “{A:5,B:2}” updated based on the local confirmation clock of the receptor Ra and the received logic clock list to the receptor Rb (step S203).

Upon the receipt of the logic clock list, the confirmation protocol control section 15 of the receptor Rb updates the logic clock list based on the local confirmation clock of the receptor Rb and the received logic clock list, and determines that the value of the global confirmation clock is “5” (step S204). Next, the confirmation protocol control section 15 of the receptor Rb transmits the logic clock list “{A:5,B:7}” updated based on the local confirmation clock of the receptor Ra and the received logic clock list to the receptor Ra (step S205).

Upon the receipt of the logic clock list, the confirmation protocol control section 15 of the receptor Ra determines that the value of the of the global confirmation clock is “7” based on the value “9” of the current local confirmation clock of the receptor Ra and the value “7” of the local confirmation clock of the receptor Rb (step S206). Next, the confirmation protocol control section 15 of the receptor Ra transmits the logic clock list “{A:9,B:7}” updated based on the local confirmation clock of the receptor Ra and the received logic clock list to the receptor Rb (step S207).

After step S208, similar to the above, the global confirmation clock is updated. Further, in FIG. 12, for convenience, a case is described where the logic clock list is exchanged between two receptors R. However, when there are three or more receptors, the logic clock list includes three or more elements (local confirmation clocks) and the logic clock list circulates among the three or more receptors R along a path which passes through all the receptors R without passing through the same receptor gain in one circulation. In this case, the minimum value of the local confirmation clock among the values of the three or more receptors is the global confirmation clock. Further, the logic clock list may pass through the containers C. However, the logic clock list is not updated in the containers C.

Namely, the logic clock list may circulate among the receptors R and the containers C along a path which passes through all the receptors R and containers C without passing through the same receptor R again in one circulation.

The confirmation processing section 24 of the container C having received the logic clock list determines the global confirmation clock based on the logic clock list. Then, the confirmation processing section 24 deletes the operation instructions from the operation instruction execution history storage section 25, the operation instructions belonging to the operation instruction sequence related to the logical clock having values equal to or less than the value of the global confirmation clock. Further, the confirmation processing section 24 selects the last (final) operation instruction sequence among the deleted operation instruction sequences, and stores the time stamp and the execution results of the last (final) operation instruction sequence into the confirmation state storage section 26.

In the receptors R, the global confirmation clock is used for the determination whether the consistent operation instruction sequence can be confirmed (in step S144 of FIG. 11). Namely, when the value of the global confirmation clock is equal to “the value of the logical clock −1” of the operation instruction, it is determined that the consistent operation instruction sequence can be confirmed. On the other hand, when the value of the global confirmation clock is less than “the value of the logical clock −1” of the operation instruction, it is determined that the consistent operation instruction sequence is not be confirmed.

As described above, in this embodiment, neither the exclusive control nor the integrated control is performed on the operation instruction sequence related to data distributively managed. Further, the operation instructions included in the operation instruction sequence are speculatively executed. Because of the features, it may become possible to improve the parallelism among the operation instruction sequences and then increase the speed of the execution of the operation instruction sequence.

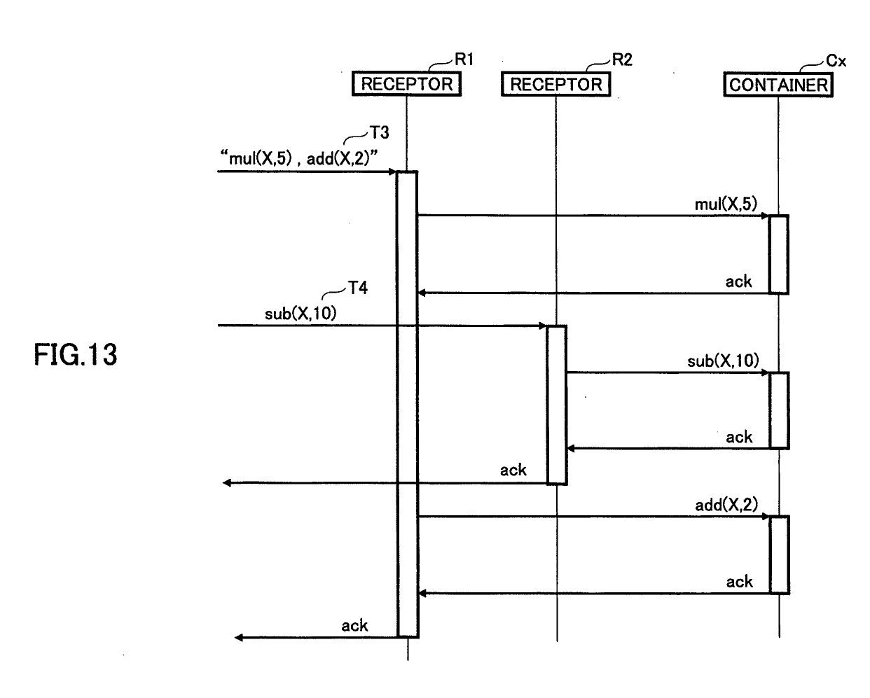

Further, the time stamp including the logical clock unique to the operation instruction sequence is added to the operation instructions included in the operation instruction sequence. Based on the time stamp, the execution order of the operation instructions is controlled. Further, when the arriving order of the operation instructions to the container C is not correct, at least the operation instructions relevant to the incorrect order are re-executed. As a result, for example, the occurrence of the problem as illustrated in FIG. 13 may be properly avoided.

FIG. 13 illustrates an example in which an operation instruction sequence interrupts the other operation instruction sequence. In the case of FIG. 13, the operation instruction sequence T4 interrupts in between the two operation instructions “mul(X,5)” and “add(X,2)” of the operation instruction sequence T3. In this embodiment, however, when the operation instruction “add(X,2)” is received by the container Cx, due to the execution of sorting based on the time stamp including the logical clock, the operation instruction sequences T3 and T4 are distinguished and executed. Therefore, the problem as illustrated in FIG. 13 may be properly avoided.

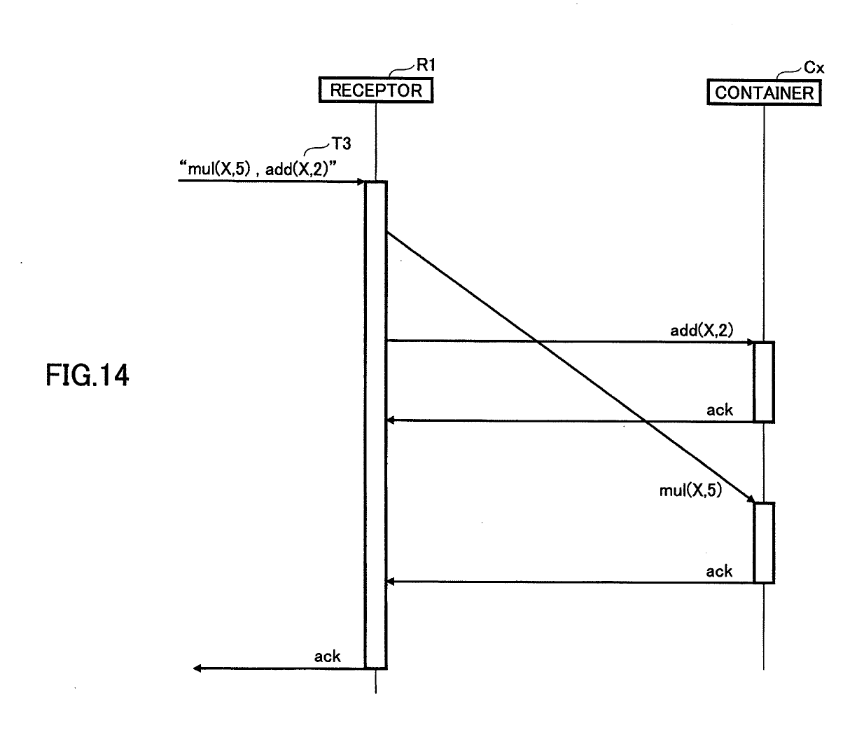

Further, the time stamp added to the operation instructions includes the operation instruction number indicating the execution order of the operation instructions included in one operation instruction sequence. Based on the time stamp, the execution order is controlled. Further, when arriving order of the operation instructions to the container C is not correct, at least the operation instructions relevant to the incorrect order are re-executed. As a result, for example, the occurrence of the problem as illustrated in FIG. 14 may be properly avoided.

FIG. 14 illustrates an example in which an execution order of operation instructions in one operation instruction sequence is inverted. In the case of FIG. 14, the execution order of the two operation instructions included in operation instruction sequence T3 is inverted. In this embodiment, however, when the operation instruction “mul(X,5)” is received at the container Cx, the operation instructions are executed based on the sorting order based on the time stamp including the operation instruction number. Therefore, the problem as illustrated in FIG. 14 may be avoided.

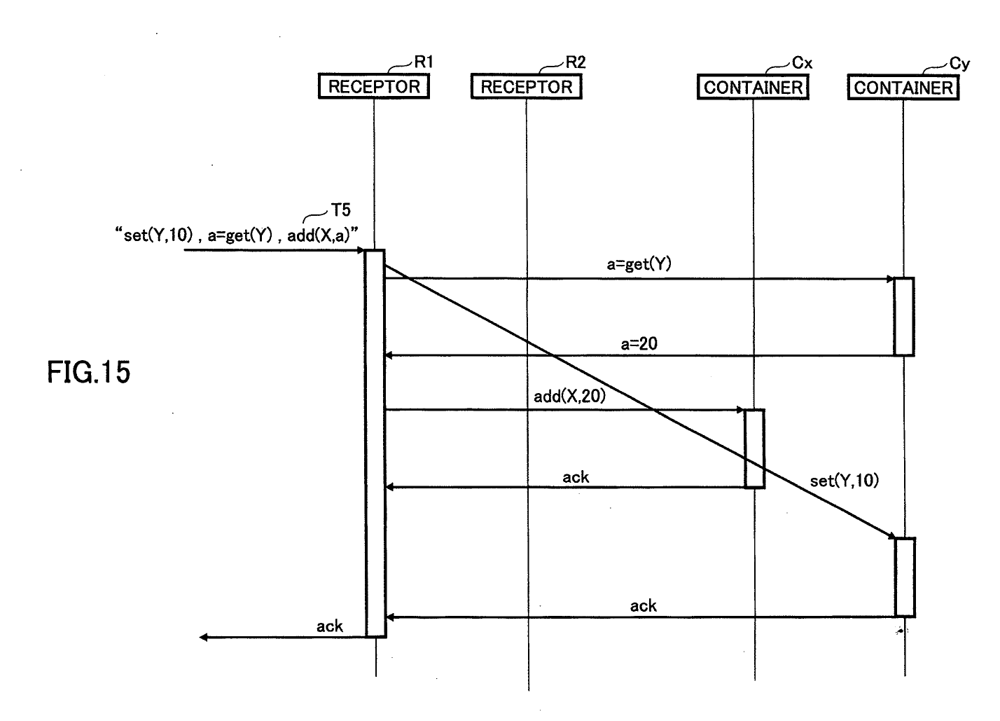

Further, in this embodiment, due to the callback process, the order relationship between the dependency source and the dependency destination may be correctly maintained. Therefore, it may become possible to correct the incorrect execution results caused by the speculative execution of the operation instruction of the dependency destination. For example, even when the status as illustrated in FIG. 15 temporarily occurs, due to the callback process, it may become possible to re-execute the operation instructions in correct order so as to correct the incorrect status.

FIG. 15 illustrates an example in which an incorrect execution result is obtained due to the speculative execution of the operation instruction of the dependent destination. FIG. 15 illustrates a case where, in the operation instruction sequence T5, before the execution of the operation instruction “set(Y,10)” that is to be executed first, the operation instruction “a=get(Y)” is executed, and by the execution of “add(X,a)” that depends on “get(Y)” via “a”, the execution result becomes incorrect. In this embodiment, however, even when such a status occurs, upon the receipt of “set(Y,10)” at the container Cy, the operation instruction “a=get(Y)” is re-executed and in response to the re-execution, the callback process is performed. As a result, the operation instruction “add(X,a)” depending on “a” may be re-executed based on the correct value “a”.

Based on the effects as described above, in this embodiment, eventual consistency in the execution of the operation instruction sequence may be ensured.

Further, due to the introduction of the confirmation protocol, the timing for the confirmation of the consistent operation instruction sequence may be detected. In a system environment where the consistent operation instruction sequence may not be required, the confirmation protocol is not always necessary. This is because the eventual consistency may be ensured without the confirmation protocol.

Further, in this embodiment, for convenience, a case is described where each container C stores one data. However, one container C may store two or more data. In this case, the operation instruction execution history storage section 25 may be provided for each of the data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it is to be understood that various changes, substitutions, and alterations could be made hereto without departing from the sprit and scope of the invention.

What is claimed is:

1. An information processing system comprising:
one or more receiving nodes, each receiving an execution request for executing an operation instruction sequence including one or more operation instructions to be sequentially executed, the one or more operation instructions being related to one or more data; and
one or more storing nodes, each storing data to be operated based on the one or more operation instructions,
wherein the receiving node includes an order information adding unit that adds first order information to the one or more operation instructions included in each of the operation instruction sequences, the first order information indicating a first order relationship among the operation instruction sequences, and an operation instruction transmission unit that transmits the one or more operation instructions to the one or more storing nodes,
the storing node includes an operation instruction execution unit that executes the one or more operation instructions related to the data stored in the storing node in response to the receipt of the one or more operation instructions, and
upon a receipt of a second operation instruction having the first order information indicating that the second operation instruction is earlier than the one or more first operation instructions, which was already executed, in the first order relationship, the operation instruction execution unit re-executes the first operation instruction after the second operation instruction is executed.

2. The information processing system according to claim 1,
wherein the order information adding unit further adds second order information to the one or more operation instructions included in a same operation instruction sequences, the second order information indicating a second order relationship between the operation instructions in the operation instruction sequence, and
upon a receipt of a fourth operation instruction having the second order information indicating that the fourth operation instruction is earlier than one or more third operation instructions in the second order relationship, the operation instruction execution unit re-executes the third operation instruction after the fourth operation instruction is executed.

3. The information processing system according to claim 1,
wherein the receiving node further includes a report instruction adding unit that, when there is a fifth operation instruction depending on an execution result of a sixth operation instruction in the operation instruction sequence, associates a report instruction with the sixth operation instruction, the report instruction indicating that the sixth operation was re-executed,
in response to the re-execution of the sixth operation instruction associated with the report instruction, the operation instruction execution unit of a first storing node reports the re-execution of the sixth operation instruction to a second storing node corresponding to data to be operated by the fifth operation instruction depending on the execution result of the sixth operation instruction, and
the second storing node causes the first storing node to execute the sixth operation instruction associated with the report instruction, and re-executes the fifth operation instruction depending on the execution result of the sixth operation instruction using the execution result of the sixth operation instruction.

4. The information processing system according to claim 3,
wherein in a case where the sixth operation instruction associated with the report instruction is re-executed, when a state of data to be operated by the sixth operation instruction after the re-execution differs from a state of the data before the re-execution, the operation instruction execution unit reports the re-execution of the sixth operation instruction.

5. The information processing system according to claim 1,
wherein in response to the execution of the operation instruction, the operation instruction execution unit reports an execution report of the operation instruction to the receiving node, and
the receiving node further includes an end processing unit that determines completion of all the operation instructions included in the operation instruction sequence based on the execution report, and further determines an output timing of an execution result of the operation instruction sequence in which all the operation instructions are completed, the determination being based on the first order information added to the operation instruction sequence in which all the operation instructions are not completed among the operation instruction sequences received by the receiving node.

6. An information processing method in an information processing system including one or more receiving nodes for receiving an execution request of an operation instruction sequence including one or more operation instructions sequentially processing one or more data, and one or more storing nodes for storing data to be operated based on the one or more operation instructions, the information processing method comprising:
adding, by the receiving node, first order information to the one or more operation instructions included in each of the operation instruction sequences, the first order information indicating a first order relationship among the operation instruction sequences;
transmitting, by the receiving node, the one or more operation instructions to the one or more storing nodes; and
executing, by the storing node, the one or more operation instructions related to the data stored in the storing node in response to the receipt of the one or more operation instructions,
wherein upon a receipt of a second operation instruction having the first order information indicating that the second operation instruction is earlier than the one or more first operation instructions, which was already executed, in the first order relationship, the storing node re-executes the first operation instruction after the second operation instruction is executed.

7. The information processing method according to claim 6,
wherein the receiving node further adds second order information to the one or more operation instructions included in a same operation instruction sequences, the second order information indicating a second order relationship between the operation instructions in the operation instruction sequence, and upon a receipt of a third operation instruction having the second order information indicating that the third operation instruction is earlier than one or more fourth operation instructions in the second order relationship, the storing node re-executes the one or more fourth operation instructions after the third operation instruction is executed.

8. The information processing method according to claim 6,
wherein when there is a fifth operation instruction depending on an execution result of a sixth operation instruction in the operation instruction sequence, the receiving node associates a report instruction with the sixth operation instruction, the report instruction indicating that the sixth operation was re-executed,
in response to the re-execution of the sixth operation instruction associated with the report instruction, a first storing node reports the re-execution of the sixth operation instruction to a second storing node corresponding to data to be operated by the fifth operation instruction depending on the execution result of the sixth operation instruction, and
the second storing node causes the first storing node to execute the sixth operation instruction associated with the report instruction, and re-executes the fifth operation instruction depending on the execution result of the sixth operation instruction using the execution result of the sixth operation instruction.

9. The information processing method according to claim 8,
wherein in a case where the sixth operation instruction associated with the report instruction is re-executed, when a state of data to be operated by the sixth operation instruction after the re-execution differs from a state of the data before the re-execution, the storing node reports the re-execution of the sixth operation instruction.

10. The information processing method according to claim 6,
wherein in response to the execution of the operation instruction, the storing node reports an execution report of the operation instruction to the receiving node, and
the receiving node determines completion of all the operation instructions included in the operation instruction sequence based on the execution reports, and further determines an output timing of an execution result of the operation instruction sequence in which all the operation instructions are completed, the determination being based on the first order information added to the operation instruction sequence in which all the operation instructions are not completed among the operation instruction sequences received by the receiving node.
